(19) United States
(12) Patent Application Publication
(10) Pub. No.: US 2026/0243960 A1
(43) Pub. Date: Aug. 20, 2026

(54) WAVEGUIDE MODE CONVERTER

(71) Applicant: NGK INSULATORS, LTD., Nagoya-shi (JP)

(72) Inventors: Kentaro TANI, Nagoya-shi (JP); Jungo KONDO, Kasugai-shi (JP)

(21) Appl. No.: 19/634,192

(22) Filed: Mar. 31, 2026

Related U.S. Application Data
(63) Continuation of application No. PCT/JP2024/033098, filed on Sep. 17, 2024.

(30) Foreign Application Priority Data
Oct. 18, 2023 (JP) 2023-179636

(51) Int. Cl. G02B 6/14; G02B 6/12; G02B 6/122

(52) U.S. Cl. CPC G02B 6/14; G02B 6/1223; G02B 2006/12038; G02B 2006/12152

(57) ABSTRACT

A waveguide mode converter includes an inorganic material substrate, a first conductor layer, a supporting substrate, a cavity portion, and a backshort conductor layer. The first conductor layer is arranged on one side of the inorganic material substrate in a thickness direction of the inorganic material substrate. The supporting substrate is arranged on an opposite side to the first conductor layer with respect to the inorganic material substrate. The cavity portion is arranged on the opposite side to the first conductor layer with respect to the inorganic material substrate, and arranged on the inorganic material substrate side of the supporting substrate. The backshort conductor layer is arranged on an internal surface of the cavity portion. The first conductor layer includes a signal wiring. The signal wiring forms a planar line. The signal wiring has one end portion overlapping the cavity portion as viewed from the thickness direction.

### CROSS-REFERENCE TO RELATED APPLICATIONS

This application is a continuation under 35 U.S.C. 120 of International Application PCT/JP2024/033098 having the International Filing Date of Sep. 17, 2024, which claims the benefit of priority of Japanese Application No. 2023-179636 filed on Oct. 18, 2023, the entire contents of which are incorporated herein by reference.

### BACKGROUND OF THE INVENTION

### 1. Field of the Invention

The present disclosure relates to a waveguide mode converter.

### 2. Description of the Related Art

In recent years, in a communication device, it has been desired to connect an antenna and a high frequency circuit to each other. It has been discussed to apply a waveguide mode converter to a connection portion between the antenna and the high frequency circuit. Such a waveguide mode converter is required to perform mutual conversion between a waveguide mode present in a waveguide tube that is connectable to the antenna and a waveguide mode present in a planar line connectable to the high frequency circuit.

As an example of such a waveguide mode converter, the following microstrip line-waveguide tube converter has been proposed (see Patent Literature 1). The microstrip line-waveguide tube converter includes a first dielectric substrate to be connected to a waveguide tube, a second dielectric substrate stacked on the first dielectric substrate, and a microstrip line formed between the first dielectric substrate and the second dielectric substrate. In such a microstrip line-waveguide tube converter, a dielectric-filled waveguide tube formed of the first dielectric substrate and the second dielectric substrate functions as a backshort portion.

### CITATION LIST

### Patent Literature

[PTL 1] JP 2008-193162 A

### SUMMARY OF THE INVENTION

However, in the microstrip line-waveguide tube converter as described in Patent Literature 1, the backshort portion is formed of the dielectric-filled waveguide tube, and hence dielectric loss of an electromagnetic wave is caused in waveguide mode conversion of the electromagnetic wave, and conversion efficiency of the electromagnetic wave may consequently become insufficient.

The present disclosure has a primary object to provide a waveguide mode converter capable of achieving excellent conversion efficiency.

[1]A waveguide mode converter according to an embodiment of the present disclosure includes an inorganic material substrate, a first conductor layer, a supporting substrate, a cavity portion, and a backshort conductor layer. The first conductor layer is arranged on one side of the inorganic material substrate in a thickness direction of the inorganic material substrate. The supporting substrate is arranged on an opposite side to the first conductor layer with respect to the inorganic material substrate. The cavity portion is arranged on the opposite side to the first conductor layer with respect to the inorganic material substrate, and arranged on the inorganic material substrate side of the supporting substrate. The backshort conductor layer is arranged in the cavity portion. The first conductor layer includes a signal wiring. The signal wiring forms a planar line capable of propagating an electromagnetic wave. The signal wiring has one end portion overlapping the cavity portion as viewed from the thickness direction of the inorganic material substrate.

[2] In the waveguide mode converter according to the above-mentioned item [1], the inorganic material substrate may include a mode conversion part overlapping the cavity portion as viewed from the thickness direction of the inorganic material substrate. The waveguide mode converter may further include a leakage suppression portion configured to suppress leakage of the electromagnetic wave from the mode conversion part. The leakage suppression portion is arranged to pass through the inorganic material substrate and surround the mode conversion part.

[3] In the waveguide mode converter according to the above-mentioned item [2], the leakage suppression portion may be formed of a plurality of conductor columns. The plurality of conductor columns are arranged at distances from each other.

[4] In the waveguide mode converter according to the above-mentioned item [2], the leakage suppression portion may be formed of a conductor wall. The conductor wall continuously extends so as to surround the mode conversion part.

[5] In the waveguide mode converter according to any one of the above-mentioned items [1] to [4], the first conductor layer may further include a first ground layer. The first ground layer is arranged at a distance from the one end portion of the signal wiring so as to surround the one end portion of the signal wiring.

[6] The waveguide mode converter according to the above-mentioned item [5] may further include a second ground layer. The second ground layer is arranged in a part different from the cavity portion between the inorganic material substrate and the supporting substrate. The second ground layer is arranged so as to surround the cavity portion as viewed in the thickness direction of the inorganic material substrate.

[7] In the waveguide mode converter according to the above-mentioned item [6], the first ground layer and the second ground layer may be electrically connected to each other.

[8] The waveguide mode converter according to any one of the above-mentioned items [1] to [7] may further include a waveguide member. The waveguide member is located on an opposite side to the inorganic material substrate with respect to the first conductor layer. The waveguide member includes a hollow waveguide extending in the thickness direction of the inorganic material substrate. The hollow waveguide is opposed to the one end portion of the signal wiring in the thickness direction of the inorganic material substrate.

[9] In the waveguide mode converter according to the above-mentioned item [8], the planar line formed of the signal wiring may be capable of propagating an electromagnetic wave in a quasi-TEM mode. The hollow waveguide may be capable of propagating an electromagnetic wave in a TE mode.

[10] The waveguide mode converter according to any one of the above-mentioned items [1] to [9] may further include a joint portion. The joint portion joins the inorganic material substrate and the supporting substrate to each other.

[11] In the waveguide mode converter according to any one of the above-mentioned items [1] to [10], the inorganic material substrate may have a thickness of 100 μm or less.

[12] In the waveguide mode converter according to any one of the above-mentioned items [1] to [11], the inorganic material substrate may be formed of quartz glass.

[13] In the waveguide mode converter according to any one of the above-mentioned items [1] to [12], a frequency of the electromagnetic wave allowed to be propagated in the waveguide mode converter may be from 20 GHz to 20 THz.

According to the embodiment of the present disclosure, the waveguide mode converter having excellent conversion efficiency can be achieved.

### BRIEF DESCRIPTION OF THE DRAWINGS

FIG. 1 is a schematic perspective view of a waveguide mode converter according to an embodiment of the present disclosure.

FIG. 2 is a cross-sectional view of the waveguide mode converter taken along the line II-II′ of FIG. 1.

FIG. 3 is a schematic cross-sectional view of a waveguide mode converter according to another embodiment of the present disclosure.

FIG. 4 is a schematic perspective view of a second conductor layer and a supporting substrate included in the waveguide mode converter of FIG. 1.

FIG. 5 is a schematic perspective view of a waveguide mode converter according to further another embodiment of the present disclosure.

FIG. 6 is a cross-sectional view of the waveguide mode converter taken along the line VI-VI′ of FIG. 5.

FIG. 7 is a schematic perspective view of a waveguide mode converter according to still another embodiment of the present disclosure.

FIG. 8 is a schematic perspective view of a waveguide mode converter according to yet another embodiment of the present disclosure.

FIG. 9 is a schematic cross-sectional view of a waveguide mode converter according to yet another embodiment of the present disclosure.

FIG. 10 is a schematic cross-sectional view of a waveguide mode converter according to yet another embodiment of the present disclosure.

FIG. 11 is a schematic cross-sectional view of a waveguide mode converter according to yet another embodiment of the present disclosure.

FIG. 12 is a schematic cross-sectional view of a waveguide mode converter according to yet another embodiment of the present disclosure.

FIG. 13 is a schematic cross-sectional view of a waveguide mode converter according to yet another embodiment of the present disclosure.

### DESCRIPTION OF THE EMBODIMENTS

Embodiments of the present disclosure are described below with reference to the drawings. However, the present disclosure is not limited to these embodiments. In addition, the drawings may be represented schematically in terms of width, thickness, shape, and the like of each component as compared to the embodiments in order to make the description clearer, but this is only an example and does not limit the interpretation of the present disclosure.

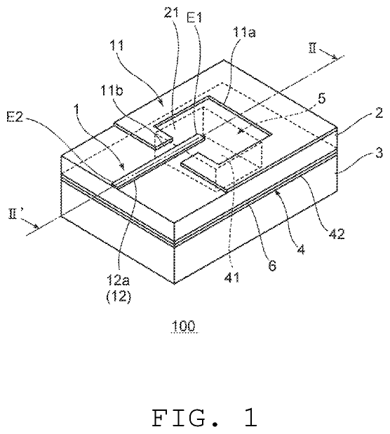

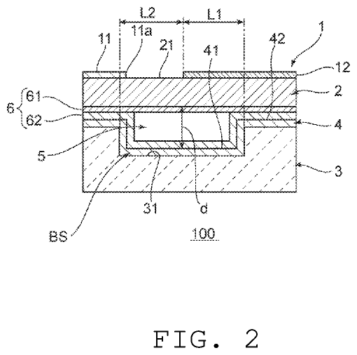

A. Overall Configuration of Waveguide Mode Converter FIG. 1 is a schematic perspective view of a waveguide mode converter according to an embodiment of the present disclosure, and FIG. 2 is a cross-sectional view of the waveguide mode converter taken along the line II-II′ of FIG. 1.

A waveguide mode converter 100 in the illustrated example includes an inorganic material substrate 2, a first conductor layer 1, a supporting substrate 3, a cavity portion 5, and a backshort conductor layer 41. The first conductor layer 1 is arranged on one side of the inorganic material substrate 2 in a thickness direction of the inorganic material substrate 2. The first conductor layer 1 includes a signal wiring 12 extending in a predetermined direction. The signal wiring 12 forms a planar line capable of propagating an electromagnetic wave. The supporting substrate 3 is arranged on an opposite side to the first conductor layer 1 with respect to the inorganic material substrate 2. The cavity portion 5 is arranged on the opposite side to the first conductor layer 1 with respect to the inorganic material substrate 2, and arranged on the inorganic material substrate side of the supporting substrate 3. The backshort conductor layer 41 is arranged in the cavity portion 5. The inorganic material substrate 2 typically includes a mode conversion part 21 overlapping the cavity portion 5 as viewed from the thickness direction of the inorganic material substrate 2. In other words, the mode conversion part 21 is a part of the inorganic material substrate 2 overlapping a projection surface on which the cavity portion 5 is projected in the thickness direction of the inorganic material substrate 2. The signal wiring 12 includes, in a direction in which the signal wiring 12 extends, a first end portion E1 serving as one end portion, and a second end portion E2 serving as another end portion. The first end portion E1 of the signal wiring 12 overlaps the cavity portion 5 as viewed from the thickness direction of the inorganic material substrate 2.

In such a waveguide mode converter 100, the mode conversion part 21 of the inorganic material substrate 2, the cavity portion 5, and the backshort conductor layer 41 form a backshort portion BS (see FIG. 2). Accordingly, as compared to a case in which the backshort portion is formed of a dielectric-filled waveguide tube, dielectric loss in waveguide mode conversion of an electromagnetic wave can be reduced, and conversion efficiency of the electromagnetic wave can be improved.

The waveguide mode converter 100 can typically perform mutual conversion between a waveguide mode present in the planar line formed of the signal wiring 12 and a waveguide mode present in a hollow waveguide. The planar line can typically propagate an electromagnetic wave in a quasi-TEM mode. The hollow waveguide can typically propagate an electromagnetic wave in a TE mode.

Typical examples of the electromagnetic wave that can be propagated in the waveguide mode converter 100 include a millimeter wave to a terahertz wave. The “millimeter wave” is typically an electromagnetic wave having a frequency of from about 20 GHz to about 300 GHz, and the “terahertz wave” is typically an electromagnetic wave having a frequency of from about 300 GHz to about 20 THz.

A frequency of the electromagnetic wave that can be propagated by the waveguide mode converter 100 is from 20 GHz to 20 THz in one example, is from 20 GHz to 500 GHz in another example, is from 20 GHz to 300 GHz in further another example, and is from 100 GHz to 200 GHz in still another example.

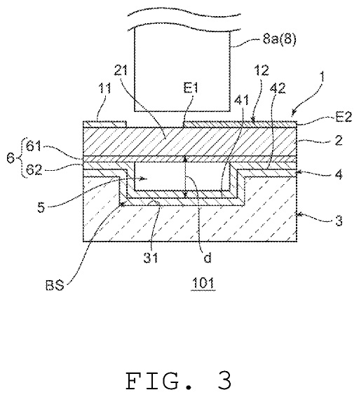

As illustrated in FIG. 3, in one embodiment, the waveguide mode converter 100 further includes a waveguide member 8 including a hollow waveguide. In the following, in some cases, the waveguide mode converter 100 including the waveguide member 8 is distinguished from the waveguide mode converter 100 not including the waveguide member 8, as a converter 101 provided with a waveguide member.

The waveguide member 8 is located on an opposite side to the inorganic material substrate 2 with respect to the first conductor layer 1. The waveguide member 8 is typically located on an opposite side to the backshort portion BS with respect to the first end portion E1 of the signal wiring 12. The hollow waveguide included in the waveguide member 8 extends in the thickness direction of the inorganic material substrate 2. The hollow waveguide is opposed to the first end portion E1 of the signal wiring 12 in the thickness direction of the inorganic material substrate 2. In the illustrated example, a center axis of the hollow waveguide and a center of the cavity portion 5 are located coaxially along the thickness direction of the inorganic material substrate 2.

The waveguide member 8 is positioned with respect to the first end portion E1 of the signal wiring 12 by any appropriate method.

The signal wiring 12 typically has a flat band shape extending linearly. The direction in which the signal wiring 12 extends is substantially orthogonal to the thickness direction of the inorganic material substrate 2. A dimension of the signal wiring 12 in a width direction (direction orthogonal to both of the thickness direction of the inorganic material substrate 2 and the direction in which the signal wiring 12 extends) is, for example, from 20 μm to 800 μm.

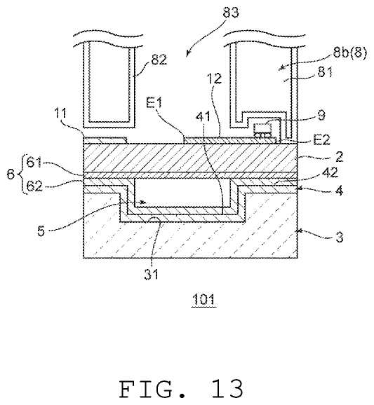

In the illustrated example, the first end portion E1 of the signal wiring 12 is arranged in the mode conversion part 21 of the inorganic material substrate 2. The second end portion E2 of the signal wiring 12 is arranged at any appropriate position in a part of the inorganic material substrate 2 that excludes the mode conversion part 21. The second end portion E2 of the signal wiring 12 is typically formed to be connectable to any appropriate external apparatus (see FIG. 13). Examples of the external apparatus include a high frequency circuit, an amplifier, and a frequency filter. In FIG. 13, an amplifier 9 is connected to the second end portion E2 of the signal wiring 12.

In such a configuration, when an electromagnetic wave (electrical signal) is input from the external apparatus to the planar line formed of the signal wiring 12, the electromagnetic wave is propagated through the planar line in a specific mode corresponding to the planar line (typically, in the quasi-TEM mode) to reach the backshort portion BS. After that, in the backshort portion BS, the electromagnetic wave is changed to a specific mode corresponding to the hollow waveguide (typically, the TE mode) to be propagated to the hollow waveguide.

As illustrated in FIG. 1, the first end portion E1 of the signal wiring 12 may overlap the center of the cavity portion 5 as viewed from the thickness direction of the inorganic material substrate 2, or may be shifted from the center.

In one embodiment, the first end portion E1 of the signal wiring 12 overlaps a middle part of the cavity portion 5 in the width direction of the signal wiring 12 as viewed from the thickness direction of the inorganic material substrate 2. With the first end portion E1 of the signal wiring 12 being arranged in this manner, the conversion efficiency of the waveguide mode converter 100 can be further improved.

Further, the first end portion E1 of the signal wiring 12 may overlap a middle part of the cavity portion 5 in the direction in which the signal wiring 12 extends as viewed from the thickness direction of the inorganic material substrate 2, or may be shifted from the middle part.

As illustrated in FIG. 2, an end edge of the first end portion E1 of the signal wiring 12 is located apart from an end edge of the cavity portion 5 in the direction in which the signal wiring 12 extends.

In one embodiment, a position of the first end portion E1 in the direction in which the signal wiring 12 extends is suitably and appropriately designed in accordance with a distance L1 between the end edge of the first end portion E1 and a first end edge of the cavity portion 5 and a distance L2 between the end edge of the first end portion E1 and a second end edge of the cavity portion 5. The first end edge of the cavity portion 5 is located between the first end portion E1 and the second end portion E2 in the direction in which the signal wiring 12 extends. The second end edge of the cavity portion 5 is located on an opposite side to the second end portion E2 with respect to the first end portion E1 in the direction in which the signal wiring 12 extends.

In the direction in which the signal wiring 12 extends, the distance L1 between the end edge of the first end portion E1 of the signal wiring 12 and the first end edge of the cavity portion 5 corresponds to a length of the signal wiring 12 entering the cavity portion 5 as viewed from the thickness direction of the inorganic material substrate 2. The distance L1 between the end edge of the first end portion E1 and the first end edge of the cavity portion 5 is, for example, from (λ/12ε) μm to (3λ/4ε) μm. (λ represents a wavelength of the electromagnetic wave propagated in the waveguide mode converter 100. ε represents a relative dielectric constant of the inorganic material substrate 2.) The distance L1 is specifically from 10 μm to 700 μm, and is from 100 μm to 500 μm in another example. In more detail, the distance L1 means a distance between the end edge of the first end portion E1 of the signal wiring 12 and a side surface corresponding to a first end edge of a recess 31 to be described later, in the direction in which the signal wiring 12 extends.

In the direction in which the signal wiring 12 extends, for example, a range of the distance L2 between the end edge of the first end portion E1 of the signal wiring 12 and the second end edge of the cavity portion 5 is similar to the above-mentioned range of the distance L1. In more detail, the distance L2 means a distance between the end edge of the first end portion E1 of the signal wiring 12 and a side surface corresponding to a second end edge of the recess 31 to be described later, in the direction in which the signal wiring 12 extends.

A shape of the first end portion E1 of the signal wiring 12 is suitably and appropriately designed. Examples of the shape of the first end portion E1 as viewed from the thickness direction of the inorganic material substrate 2 include polygonal shapes such as a rectangular shape, a circular shape, an oval shape, a tapered shape, and other different shapes.

As illustrated in FIG. 1, in one embodiment, the first conductor layer 1 further includes a first ground layer 11. The first ground layer 11 is arranged at a distance from the first end portion E1 of the signal wiring 12 so as to surround the first end portion E1 of the signal wiring 12. When the first conductor layer 1 includes the first ground layer 11, it is possible to suppress leakage of the electromagnetic wave from the backshort portion BS.

In the illustrated example, the first ground layer 11 includes an opening portion 11a and a slit 11b. The opening portion 11a of the first ground layer 11 corresponds to the mode conversion part 21 of the inorganic material substrate 2, and exposes the mode conversion part 21. The slit 11b is formed by cutting out a part of the first ground layer 11 that defines the opening portion 11a. The slit 11b is continuous with the opening portion 11a. The slit 11b typically extends in the same direction as the signal wiring 12. In the slit 11b, a part of the signal wiring 12 between the first end portion E1 and the second end portion E2 is located. The first end portion E1 of the signal wiring 12 is located in the opening portion 11a.

As illustrated in FIG. 2, in one embodiment, the waveguide mode converter 100 further includes a second ground layer 42. The second ground layer 42 is arranged in a part different from the cavity portion 5 between the inorganic material substrate 2 and the supporting substrate 3. The second ground layer 42 is arranged so as to surround the entire cavity portion 5 as viewed from the thickness direction of the inorganic material substrate 2. With such a configuration, it is possible to stably suppress leakage of the electromagnetic wave from the backshort portion BS.

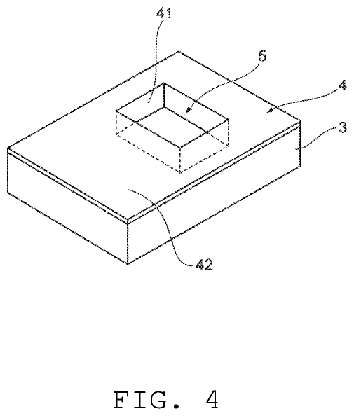

The second ground layer 42 may be arranged at a distance from the backshort conductor layer 41, or may be continuous with the backshort conductor layer 41. In the illustrated example, the second ground layer 42 is continuous with the backshort conductor layer 41 (see FIG. 4). When the second ground layer 42 and the backshort conductor layer 41 are continuous with each other, the function of the ground is stable across the entire substrate, and the waveguide mode converter 100 can be easily designed and manufactured.

Further, at least a part of the second ground layer 42 overlaps the first ground layer 11 as viewed from the thickness direction of the inorganic material substrate 2.

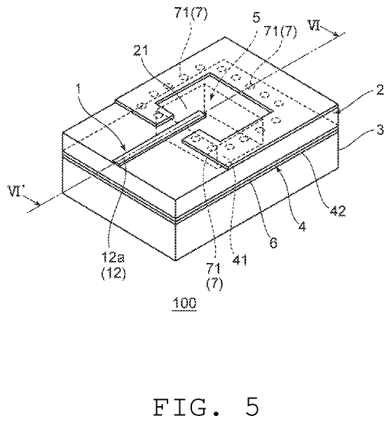

As illustrated in FIG. 5, in one embodiment, the waveguide mode converter 100 further includes a leakage suppression portion 7. The leakage suppression portion 7 is configured to suppress leakage of the electromagnetic wave from the mode conversion part 21 of the inorganic material substrate 2. The leakage suppression portion 7 is arranged to pass through the inorganic material substrate 2 and surround the mode conversion part 21.

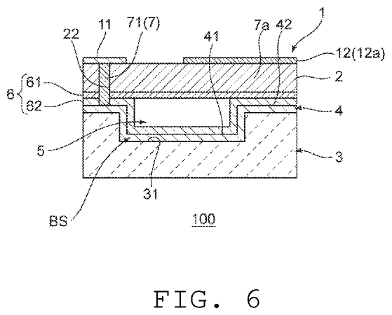

As illustrated in FIG. 6, the leakage suppression portion 7 typically includes a passage opening 7a that allows passage of the electromagnetic wave. The passage opening 7a is arranged in a part of the leakage suppression portion 7 overlapping the signal wiring 12 as viewed from the thickness direction of the inorganic material substrate 2 (see FIG. 5). The leakage suppression portion 7 is typically formed of a conductor material, and is preferably formed of a metal (described later) similar to that of the first conductor layer 1.

In the illustrated example, the leakage suppression portion 7 is formed of a plurality of conductor columns 71. The plurality of conductor columns 71 are arranged at appropriate distances from each other except for a part corresponding to the passage opening 7a (see FIG. 5). Each of the plurality of conductor columns 71 typically passes through the inorganic material substrate 2 in the thickness direction. The conductor column 71 is arranged in a through hole 22 formed in the inorganic material substrate 2. That is, in this embodiment, the inorganic material substrate 2 includes a plurality of through holes 22 so as to correspond to the plurality of conductor columns 71. In one embodiment, the conductor column 71 is formed of a conductor material filled in the through hole 22. Further, the conductor column 71 may be formed of a conductive film formed on an internal surface of the through hole 22.

A distance between conductor columns 71 adjacent to each other among the plurality of conductor columns 71 is suitably and appropriately adjusted in accordance with the wavelength of the electromagnetic wave to be propagated. The distance between center axes of the conductor columns 71 adjacent to each other is, for example, from 30 μm to 400 μm, preferably from 60 μm to 300 μm (see FIG. 5).

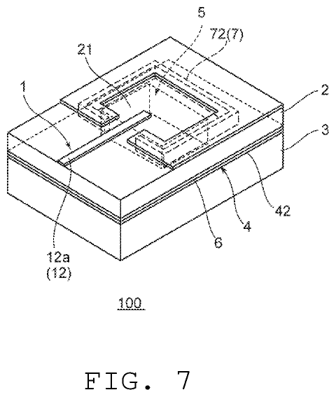

Further, as illustrated in FIG. 7, the leakage suppression portion 7 may be formed of a conductor wall 72. The conductor wall 72 extends continuously so as to surround the mode conversion part 21 except for a part corresponding to the passage opening 7a. In the illustrated example, the conductor wall 72 has a substantially rectangular tube shape, and a part of the conductor wall 72 is cut out to form the passage opening 7a.

As illustrated in FIG. 6, in one embodiment, the first ground layer 11 and the second ground layer 42 are electrically connected to each other. When the first ground layer 11 and the second ground layer 42 are electrically connected to each other, the ground can be strengthened, and stray capacitance due to a line or an element in the surroundings can be suppressed. Further, it is possible to suppress leakage of the electromagnetic wave from the backshort portion BS more stably.

In the illustrated example, the first ground layer 11 and the second ground layer 42 are electrically connected to each other via the leakage suppression portion 7. More specifically, one end portion of the leakage suppression portion 7 in the thickness direction of the inorganic material substrate 2 is in contact with the first ground layer 11, and another end portion of the leakage suppression portion 7 in the thickness direction of the inorganic material substrate 2 is in contact with the second ground layer 42.

In one embodiment, the signal wiring 12 forms a microstrip line together with the second ground layer 42. The signal wiring 12 forming the microstrip line is hereinafter sometimes referred to as “MS-type signal wiring 12a.” In this embodiment, the second ground layer 42 extends to overlap at least a part of the MS-type signal wiring 12a as viewed from the thickness direction of the inorganic material substrate 2.

With such a configuration, when a voltage is applied to the MS-type signal wiring 12a and the second ground layer 42, an electric field is generated between the MS-type signal wiring 12a and the second ground layer 42. Accordingly, an electromagnetic wave input from the external apparatus can couple to the electric field generated between the MS-type signal wiring 12a and the second ground layer 42 and be propagated through the inorganic material substrate 2 to reach the backshort portion BS.

A dimension of the MS-type signal wiring 12a in the width direction is, for example, from 20 μm to 800 μm, preferably from 50 μm to 500 μm. Further, the dimension of the MS-type signal wiring 12a in the width direction may be changed along the propagation direction of the electromagnetic wave.

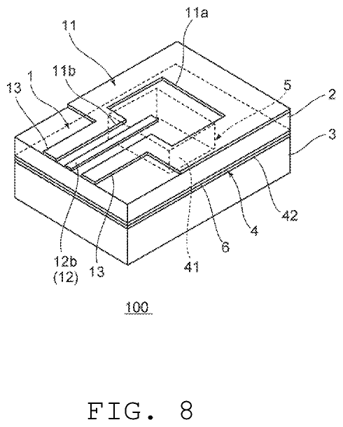

Further, as illustrated in FIG. 8, in another embodiment, the signal wiring 12 forms a coplanar line together with third ground layers 13. In this embodiment, the first conductor layer 1 further includes the third ground layers 13. The signal wiring 12 forming the coplanar line is hereinafter sometimes referred to as “CP-type signal wiring 12b.” The third ground layers 13 are arranged to sandwich the CP-type signal wiring 12b in the width direction of the CP-type signal wiring 12b. In the width direction of the signal wiring 12, an air gap portion (slit) is formed between the third ground layer 13 and the CP-type signal wiring 12b.

With such a configuration, when a voltage is applied to the CP-type signal wiring 12b, an electric field is generated between the CP-type signal wiring 12b and the third ground layers 13. Accordingly, an electromagnetic wave input from the external apparatus can couple to the electric field generated between the CP-type signal wiring 12b and the third ground layers 13 and be propagated through the inorganic material substrate 2 to reach the backshort portion BS.

The third ground layers 13 may be arranged at a distance from the first ground layer 11, or may be continuous with the first ground layer 11. In the illustrated example, the third ground layers 13 are continuous with the first ground layer 11. In more detail, the third ground layers 13 are connected to parts of the first ground layer 11 adjacent to the slit 11b. In this manner, the air gap portion between the third ground layer 13 and the CP-type signal wiring 12b communicates with the opening portion 11a of the first ground layer 11 via the slit 11b of the first ground layer 11.

A dimension of the CP-type signal wiring 12b in the width direction is, for example, from 2 μm to 200 μm, preferably from 20 μm to 150 μm. Further, a dimension of the CP-type signal wiring 12b in the width direction may change along the propagation direction of the electromagnetic wave.

A width of the air gap portion between the third ground layer 13 and the CP-type signal wiring 12b is, for example, from 2 μm to 100 μm, preferably from 5 μm to 80 μm. Further, the width of the air gap portion between the third ground layer 13 and the CP-type signal wiring 12b may change along the propagation direction of the electromagnetic wave.

Further, in the waveguide mode converter 100 including the CP-type signal wiring 12b, the second ground layer 42 preferably extends to overlap at least a part of each of the CP-type signal wiring 12b and the third ground layer 13 as viewed from the thickness direction of the inorganic material substrate 2. With such a configuration, it is possible to prevent the electric field generated between the CP-type signal wiring 12b and the third ground layer 13 from leaking to the supporting substrate 3. Moreover, it is possible to suppress the occurrence of resonance and/or stray capacitance, and to suppress a change in mode conversion characteristics due to a variation in dimensions.

As used herein, the “waveguide mode converter” includes both of a wafer in which at least one waveguide mode converter is formed (waveguide mode converter wafer) and a chip obtained by cutting the waveguide mode converter wafer.

### B. Details of Waveguide Mode Converter

Referring to FIG. 1 and FIG. 2, details of each member of the waveguide mode converter 100 are described below.

### B-1. Inorganic Material Substrate

The inorganic material substrate 2 has an upper surface on which the first conductor layer 1 is arranged, and a lower surface located inside the waveguide mode converter 100. A thickness “t” of the inorganic material substrate 2 typically satisfies the following expression (1).

$$t < \frac{λ}{a \sqrt{ε}} \qquad ( 1 )$$

(In the expression, “t” represents a thickness of the inorganic material substrate 2. A represents a wavelength of an electromagnetic wave propagated in the waveguide mode converter 100. ε represents a relative dielectric constant of the inorganic material substrate 2. “a” represents a numerical value of 3 or more.)

In the expression (1), “a” preferably represents a numerical value of 6 or more.

The thickness of the inorganic material substrate 2 is, for example, 1 μm or more, preferably 2 μm or more, more preferably 10 μm or more, still more preferably 20 μm or more, particularly preferably 30 μm or more, more particularly preferably 40 μm or more. When the thickness of the inorganic material substrate 2 is smaller than such lower limits, the thickness and size of the signal wiring 12 are reduced to about several micrometers, and it becomes difficult to achieve impedance matching with the signal wiring 12. Further, a tolerance in transmission performance due to manufacturing variations is significantly reduced in some cases.

Meanwhile, the thickness of the inorganic material substrate 2 is, for example, 500 μm or less, preferably 200 μm or less, more preferably 100 μm or less, still more preferably 80 μm or less, particularly preferably 60 μm or less.

When the inorganic material substrate 2 has such a thickness, it is possible to stably suppress the inducement of a slab mode and/or the resonance of the inorganic material substrate 2. Accordingly, it is possible to reduce loss at the time when the waveguide mode converter 100 propagates the electromagnetic wave. As a result, it is possible to further improve the conversion efficiency of the electromagnetic wave in the waveguide mode converter 100.

Further, in recent years, development of downsizing of the communication device to which the waveguide mode converter 100 is applied is in progress, and accompanying downsizing of the waveguide mode converter 100 is predicted to be required as well. In the waveguide mode converter 100, when the thickness of the inorganic material substrate 2 satisfies the above-mentioned thickness, the inorganic material substrate 2 can be thinned, and hence the demand for downsizing can also be met while the conversion efficiency in the waveguide mode converter 100 is improved.

The relative dielectric constant s of the inorganic material substrate 2 at 300 GHz, is, for example, 12.0 or less, preferably 10.0 or less, more preferably 5.0 or less. A lower limit of the relative dielectric constant s of the inorganic material substrate 2 at 300 GHz is typically 3.5. A dielectric loss tangent (dielectric loss) tanδ of the inorganic material substrate 2 at 300 GHz is, for example, 0.0030 or less, preferably 0.0020 or less, more preferably 0.0015 or less.

When the relative dielectric constant s and the dielectric loss tangent (dielectric loss) tanδ of the inorganic material substrate 2 fall within such ranges, the dielectric loss in the waveguide mode converter 100 can be further reduced. The relative dielectric constant s and the dielectric loss tangent (dielectric loss) tanδ can be measured by, for example, terahertz time domain spectroscopy. In addition, herein, when a measurement frequency is not mentioned with regard to the relative dielectric constant and the dielectric loss tangent, the relative dielectric constant and the dielectric loss tangent at 300 GHz are meant.

The inorganic material substrate 2 is formed of an inorganic material. Any appropriate material may be employed as the inorganic material as long as the effects according to the embodiments of the present disclosure are obtained. Examples of the inorganic material for forming the inorganic material substrate 2 include monocrystalline quartz (relative dielectric constant: 4.5, dielectric loss tangent: 0.0013), amorphous quartz (quartz glass, relative dielectric constant: 3.8, dielectric loss tangent: 0.0010), spinel (relative dielectric constant: 8.3, dielectric loss tangent: 0.0020), AlN (relative dielectric constant: 8.5, dielectric loss tangent: 0.0015), sapphire (relative dielectric constant: 9.4, dielectric loss tangent: 0.0030), SiC (relative dielectric constant: 9.8, dielectric loss tangent: 0.0022), magnesium oxide (relative dielectric constant: 10.0, dielectric loss tangent: 0.0012), and silicon (relative dielectric constant: 11.7, dielectric loss tangent: 0.0016). Of those inorganic materials, amorphous quartz (quartz glass) is preferred.

When the inorganic material substrate 2 is formed of quartz glass, propagation loss in the waveguide mode converter 100 can be reduced more stably. Further, the quartz glass substrate has a large dielectric constant as compared to a resin-based substrate, and hence can be reduced in substrate size, and besides, has a relatively small dielectric constant among inorganic materials, and hence is advantageous in achieving a low delay. In addition, the first conductor layer 1 (metal layer) can be formed without surface roughening or surface treatment.

Although not shown, the inorganic material substrate 2 may be curved so that a part thereof overlapping the cavity portion 5 as viewed from the thickness direction sinks into the cavity portion 5.

### B-2. First Conductor Layer

In one embodiment, the first conductor layer 1 including the signal wiring 12 is arranged on a surface (one surface in the thickness direction) of the inorganic material substrate 2, and is in direct contact with the inorganic material substrate 2. That is, the signal wiring 12 is arranged directly on the inorganic material substrate 2.

The first conductor layer 1 typically includes the above-mentioned first ground layer 11 in addition to the signal wiring 12. Further, when the signal wiring 12 forms a coplanar line, the first conductor layer 1 further includes the above-mentioned third ground layers 13 (see FIG. 8).

The first conductor layer 1 is typically formed of a metal. Examples of the metal include chromium (Cr), nickel (Ni), copper (Cu), and gold (Au). The metals may be used alone or in combination thereof. The first conductor layer 1 may be a single layer, or may be formed as a laminate of two or more layers. A thickness of the first conductor layer 1 is, for example, from 1 μm to 20 μm, preferably from 4 μm to 10 μm.

### B-3. Supporting Substrate

The supporting substrate 3 can impart excellent strength to the waveguide mode converter 100. In the illustrated example, the supporting substrate 3 supports the inorganic material substrate 2 via the second ground layer 42 and a joint portion 6 (described later). The supporting substrate 3 is bonded to the inorganic material substrate 2 to reinforce the inorganic material substrate 2. In other words, the supporting substrate 3 is a reinforcing substrate for reinforcing the inorganic material substrate 2. With this configuration, the inorganic material substrate 2 can be thinned as described above. The supporting substrate 3 has any appropriate configuration.

Examples of a material for forming the supporting substrate 3 include indium phosphide (InP), silicon (Si), glass, SiAlON (Si₃N₄—Al₂O₃), mullite (3Al₂O₃·2SiO₂, 2Al₂O₃·3SiO₂), aluminum nitride (AlN), magnesium oxide (MgO), aluminum oxide (Al₂O₃), spinel (MgAl₂O₄), sapphire, quartz, crystal, gallium nitride (GaN), silicon carbide (SiC), silicon nitride (Si₃N₄), and gallium oxide (Ga₂O₃).

A thermal conductivity of the material for forming the supporting substrate 3 is preferably 150 W/Km or more, more preferably 200 W/Km or more.

When the external apparatus is connected to the waveguide mode converter 100, the inorganic material substrate 2 may be heated by the external apparatus, and the heat of the inorganic material substrate 2 may adversely affect the external apparatus. In this regard, when the material for forming the supporting substrate 3 has the above-mentioned thermal conductivity, the supporting substrate 3 functions as a heat sink, and hence the heat of the inorganic material substrate 2 can be dissipated smoothly.

Of the materials for forming the supporting substrate 3, silicon (thermal conductivity: about 160 W/Km), silicon carbide (thermal conductivity: about 270 W/Km), and aluminum nitride (thermal conductivity: from about 150 W/Km to about 250 W/Km) are preferred from the viewpoint of the thermal conductivity.

Further, a linear expansion coefficient of the material for forming the supporting substrate 3 is preferably as close to a linear expansion coefficient of the material for forming the inorganic material substrate 2 as possible. The linear expansion coefficient of the material for forming the supporting substrate 3 falls within the range of, for example, from 50% to 150% with respect to the linear expansion coefficient of the material for forming the inorganic material substrate 2. When the linear expansion coefficient of the material for forming the supporting substrate 3 falls within such a range, thermal deformation (typically, warpage) of the waveguide mode converter 100 can be suppressed.

Of those materials for forming the supporting substrate 3, indium phosphide, silicon, aluminum nitride, gallium nitride, silicon carbide, and silicon nitride are preferred, silicon, aluminum nitride, gallium nitride, silicon carbide, and silicon nitride are more preferred, and silicon is particularly preferred.

As illustrated in FIG. 2, in one embodiment, the supporting substrate 3 includes the recess 31 corresponding to the cavity portion 5. With such a configuration, with the dimension of the recess 31 being adjusted, the dimension of the cavity portion 5 can be adjusted with high accuracy in a relatively wide range. Accordingly, it is possible to easily achieve the backshort portion BS having a desired dimension.

The recess 31 is typically recessed from an upper surface (surface on the inorganic material substrate 2 side) of the supporting substrate 3 downward (direction away from the inorganic material substrate 2). The recess 31 has, as viewed from the thickness direction of the inorganic material substrate 2, the same shape as that of the cavity portion 5. In the illustrated example, the recess 31 has, in a cut surface obtained by cutting the supporting substrate 3 in its thickness direction, a substantially U shape that is open toward the inorganic material substrate 2. An internal surface of the recess 31 includes side surfaces and a bottom surface. In the illustrated example, the side surfaces of the recess 31 extend in the thickness direction of the inorganic material substrate 2. The bottom surface of the recess 31 extends in a direction intersecting with the thickness direction of the inorganic material substrate 2 (typically, a direction orthogonal thereto).

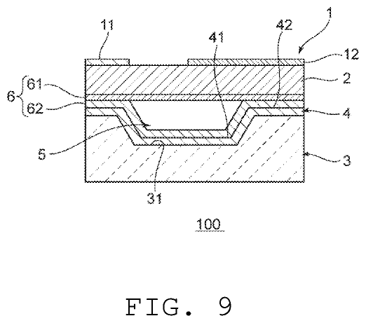

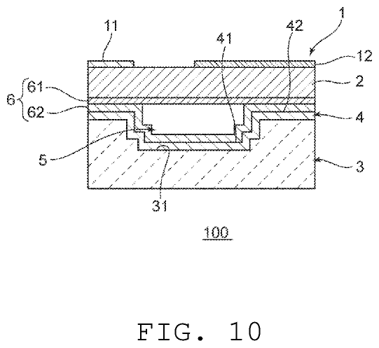

As illustrated in FIG. 9, the side surface of the recess 31 may be inclined with respect to the thickness direction of the inorganic material substrate 2. In the illustrated example, the side surface of the recess 31 is inclined inward as separating away from the inorganic material substrate 2. Further, as illustrated in FIG. 10, the side surface of the recess 31 may have a step difference.

### B-4. Second Conductor Layer

As illustrated in FIG. 2, in one embodiment, the waveguide mode converter 100 includes a second conductor layer 4. The second conductor layer 4 is arranged between the inorganic material substrate 2 and the supporting substrate 3. The second conductor layer 4 is typically arranged on the upper surface (surface on the inorganic material substrate 2 side) of the supporting substrate 3, and is brought into direct contact with the supporting substrate 3.

The second conductor layer 4 includes at least the backshort conductor layer 41. In the illustrated example, the backshort conductor layer 41 is arranged on the entire internal surface of the recess 31 of the supporting substrate 3.

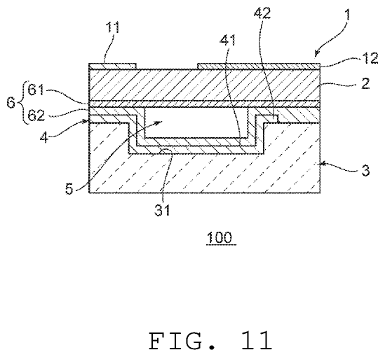

In one embodiment, the second conductor layer 4 further includes the second ground layer 42. The second ground layer 42 is arranged at any appropriate position as long as the second ground layer 42 surrounds the cavity portion 5 as described above. The second ground layer 42 is arranged on a part of the upper surface (surface on the inorganic material substrate 2 side) of the supporting substrate 3 that excludes the recess 31. The second ground layer 42 may be partially arranged on the part of the upper surface of the supporting substrate 3 that excludes the recess 31 (see FIG. 11), or may be arranged on the entire part of the upper surface of the supporting substrate 3 that excludes the recess 31 (see FIG. 4).

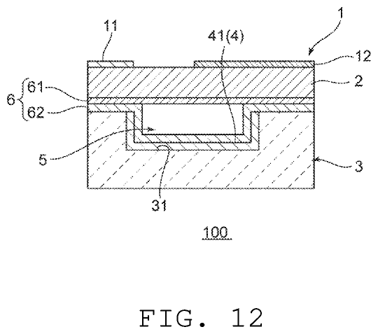

In one embodiment, the second ground layer 42 is arranged on the entire part of the upper surface of the supporting substrate 3 that excludes the recess 31. In the illustrated example, the second ground layer 42 and the backshort conductor layer 41 are continuous with each other. Further, as illustrated in FIG. 12, the second conductor layer 4 may be formed of only the backshort conductor layer 41 without including the second ground layer 42.

The second conductor layer 4 is, for example, formed of the same metal as that of the first conductor layer 1.

A thickness of the second conductor layer 4 is typically smaller than the thickness of the first conductor layer 1. The thickness of the second conductor layer 4 is, for example, from 1 nm to 30 μm, preferably from 10 nm to 10 μm.

### B-5. Joint Portion

As illustrated in FIG. 1 and FIG. 2, in one embodiment, the waveguide mode converter 100 further includes the joint portion 6. The joint portion 6 joins the inorganic material substrate 2 and the supporting substrate 3 to each other. In the illustrated example, the joint portion 6 is provided at least between the inorganic material substrate 2 and the second ground layer 42.

The joint portion 6 may be formed of an organic material (typically, an organic adhesive), or may be formed of an inorganic material. In one embodiment, the joint portion 6 is formed of an inorganic material. Examples of the inorganic material for forming the joint portion 6 include SiO₂, amorphous silicon, and tantalum oxide, and amorphous silicon is preferred.

A thickness of the joint portion 6 is, for example, from 0.001 μm to 10 μm, preferably from 0.01 μm to 3 μm.

A material for forming the joint portion 6 may be an amorphous material of the material for forming the inorganic material substrate 2, an amorphous material of the material for forming the supporting substrate 3, or the material of the second ground layer 42.

The joint portion 6 may have a single-layer structure, or may have a laminate structure. When the joint portion 6 has a laminate structure, layers formed of materials different from each other or materials being the same material but having different compositions or densities are laminated.

In one embodiment, the inorganic material substrate 2 and the supporting substrate 3 are directly joined to each other. With this configuration, the joint portion 6 is formed between the inorganic material substrate 2 and the supporting substrate 3. As used herein, the term “direct joining” means that two layers or substrates are joined to each other without an organic material (typically, an organic adhesive) being interposed therebetween. The form of the direct joining may be appropriately set in accordance with the configurations of the layers or substrates to be joined to each other. Further, an interface joined by the direct joining is typically amorphized. Accordingly, the thermal resistance of the joining interface can be dramatically reduced as compared to resin joining. Thus, in the case in which the external apparatus is connected to the waveguide mode converter 100, even when heat generated from the external apparatus is transferred to the inorganic material substrate 2, such heat can be smoothly allowed to escape from the inorganic material substrate 2 to a package via the supporting substrate 3. As a result, the heat can be efficiently dissipated from the inorganic material substrate 2, and a degradation in characteristics of the external apparatus can be suppressed.

Further, when those components are integrated by the direct joining, peeling in the waveguide mode converter 100 can be satisfactorily suppressed, and as a result, damage (e.g., a crack) to the inorganic material substrate 2 resulting from such peeling can be satisfactorily suppressed.

Further, when those components are integrated by the direct joining without the interposition of a resin, heat resistance and chemical resistance in a back-end process of the manufacture can be improved, and hence the flexibility of selection of a processing process of the waveguide mode converter 100 can be improved. Further, as compared to a case in which the joint portion 6 is formed of an organic material, the thermal expansion coefficient and the water absorption rate of the joint portion 6 can be reduced. As a result, it is possible to improve the connection reliability between the inorganic material substrate 2 and the supporting substrate 3, and to improve the reliability of the waveguide mode converter 100 as a device exposed to an external environment.

The joint portion 6 may have a single-layer structure, or may have a laminate structure. As illustrated in FIG. 2, in one embodiment, the joint portion 6 has a laminate structure. The joint portion 6 includes a first joint layer 61 and a second joint layer 62.

In one embodiment, the first joint layer 61 is arranged on a surface of the inorganic material substrate 2. More specifically, the first joint layer 61 is arranged on a surface of the inorganic material substrate 2 on the opposite side to the first conductor layer 1 in the thickness direction of the inorganic material substrate 2. In the illustrated example, the first joint layer 61 is arranged on the lower surface (surface on the opposite side to the first conductor layer 1) of the inorganic material substrate 2, and is brought into direct contact with the inorganic material substrate 2. The first joint layer 61 may be partially arranged on the lower surface of the inorganic material substrate 2, or may be arranged on the entire lower surface of the inorganic material substrate 2. In the illustrated example, the first joint layer 61 is arranged on the entire lower surface of the inorganic material substrate 2.

A thickness of the first joint layer 61 is, for example, from 0.5 nm to 5 μm, preferably from 0.01 μm to 1.5 μm, more preferably from 0.01 μm to 0.05 μm.

In one embodiment, the second joint layer 62 is arranged on a surface of the second ground layer 42. More specifically, the second joint layer 62 is arranged on a surface of the second ground layer 42 on an opposite side to the supporting substrate 3 in the thickness direction of the inorganic material substrate 2. In the illustrated example, the second joint layer 62 is arranged on an upper surface (surface on the opposite side to the supporting substrate 3) of the second ground layer 42, and is brought into direct contact with the second ground layer 42. The second joint layer 62 may be arranged only on the second ground layer 42, or may be arranged on the backshort conductor layer 41 in addition to the second ground layer 42. In the illustrated example, the second joint layer 62 is arranged on the entire upper surface of each of the backshort conductor layer 41 and the second ground layer 42. In other words, the second joint layer 62 is stacked on the entire second conductor layer 4.

The range of a thickness of the second joint layer 62 is the same as, for example, the above-mentioned range of the thickness of the first joint layer 61.

The second joint layer 62 is joined to the first joint layer 61 to be integrated with the first joint layer 61. In the illustrated example, a part of the second joint layer 62 that is located on the second ground layer 42 is directly joined to the first joint layer 61.

Further, as illustrated in FIG. 6, when the waveguide mode converter 100 includes the leakage suppression portion 7, the leakage suppression portion 7 typically collectively passes through the inorganic material substrate 2 and the joint portion 6 (first joint layer 61 and second joint layer 62).

As illustrated in FIG. 12, when the second conductor layer 4 is formed only of the backshort conductor layer 41, at least a part of the joint portion 6 is located between a part of the upper surface of the supporting substrate 3 that excludes the recess 31 and the inorganic material substrate 2, and joins the part of the upper surface of the supporting substrate 3 and the inorganic material substrate 2 to each other.

### B-6. Cavity Portion

In one embodiment, as illustrated in FIG. 2, the cavity portion 5 is included in the backshort portion BS, and is formed of a groove (recess 31) formed in the supporting substrate 3. The cavity portion 5 is typically defined by the lower surface of the inorganic material substrate 2 (more specifically, the mode conversion part 21) and the internal surface of the recess 31. In the illustrated example, in the cavity portion 5, the first joint layer 61 arranged on the lower surface of the inorganic material substrate 2 (mode conversion part 21), the backshort conductor layer 41 arranged on the internal surface of the recess 31, and the second joint layer 62 arranged on the upper surface of the backshort conductor layer 41 are arranged.

Further, in one embodiment, the cavity portion 5 includes a space in which air is present. The space is defined by the lower surface of the inorganic material substrate 2 (mode conversion part 21) or the first joint layer 61 arranged on the lower surface of the inorganic material substrate 2, and the upper surface of the backshort conductor layer 41 or the second joint layer 62 arranged on the upper surface of the backshort conductor layer 41.

As illustrated in FIG. 3, when the waveguide mode converter 100 includes the waveguide member 8 including the hollow waveguide, air is present also in the hollow waveguide. That is, air is present in each of the cavity portion 5 included in the backshort portion BS and the hollow waveguide, and hence, as compared to a case in which the cavity portion 5 included in the backshort portion BS is filled with a dielectric material, a high-order mode can be stably suppressed, and the backshort portion BS can be easily designed. The space included in the cavity portion 5 can also be brought into a vacuum state.

The cavity portion 5 has a suitable and appropriate shape and size. With the shape and the size of the cavity portion 5 being adjusted, the characteristics of the waveguide mode converter 100 (e.g., a resonant frequency or a band) can be suitably and appropriately adjusted.

The shape of the cavity portion 5 as viewed from the thickness direction of the inorganic material substrate 2 is suitably and appropriately changed in accordance with a cross-sectional shape of the hollow waveguide included in the waveguide member 8. Examples of the shape of the cavity portion 5 as viewed from the thickness direction of the inorganic material substrate 2 include a triangle, a quadrangle, a pentagon, a substantial polygon having six or more sides, a substantially circular shape, and a substantially oval shape.

In one embodiment, the shape of the cavity portion 5 as viewed from the thickness direction of the inorganic material substrate 2 is substantially the same as the cross-sectional shape of the hollow waveguide. In the illustrated example, the cavity portion 5 as viewed from the thickness direction of the inorganic material substrate 2 has a substantially rectangular shape that is the same as the cross-sectional shape of the hollow waveguide (see FIG. 1).

Further, in a cut surface obtained by cutting the waveguide mode converter 100 in the thickness direction of the inorganic material substrate 2, the cavity portion 5 has any appropriate shape. Examples of the cross-sectional shape of the cavity portion 5 include a triangle, a quadrangle (see FIG. 2 and FIG. 9), a pentagon, and a substantial polygon having six or more sides (see FIG. 10).

A maximum dimension “d” (hereinafter referred to as “depth d”) of the cavity portion 5 in the thickness direction of the inorganic material substrate 2 is suitably and appropriately changed in accordance with the configuration of the waveguide mode converter 100 and the frequency of the electromagnetic wave propagated by the waveguide mode converter 100. In one embodiment, the depth “d” of the cavity portion 5 is set within a range of from (λg/4)/3 μm to (λg/4)×4 μm. λg represents an in-tube wavelength [μm] of the hollow waveguide included in the waveguide member 8.

The depth “d” of the cavity portion 5 is specifically from 10 μm to 500 μm. The depth “d” of the cavity portion 5 refers to a distance in the thickness direction of the inorganic material substrate 2 between the inorganic material substrate 2 (more specifically, a surface in the mode conversion part 21 on an opposite side to the first conductor layer 1) and the backshort conductor layer 41 located on the bottom surface of the recess 31 (more specifically, a surface of the backshort conductor layer 41 on an opposite side to the supporting substrate 3).

### B-7. Waveguide Member

In one embodiment, the waveguide mode converter 100 includes the waveguide member 8 including a hollow waveguide. Examples of the waveguide member 8 including the hollow waveguide include a waveguide tube 8a and a waveguide substrate 8b.

The waveguide tube 8a typically extends in the thickness direction of the inorganic material substrate 2. An internal space of the waveguide tube 8a functions as the hollow waveguide. Examples of a material of the waveguide tube 8a include a metal similar to that of the first conductor layer 1 described above. The waveguide tube 8a may be a rectangular waveguide tube or a circular waveguide tube.

As illustrated in FIG. 13, the waveguide substrate 8b typically includes a substrate main body 81 having a through hole 83, and a metal layer 82. The metal layer 82 is arranged at least on an internal surface of the through hole 83. In one embodiment, the metal layer 82 is arranged on the entire surface of the substrate main body 81 including the internal surface of the through hole 83. Examples of a material of the metal layer 82 include a metal similar to that of the first conductor layer 1 described above. In the waveguide substrate 8b, a space surrounded by the metal layer 82 arranged on the internal surface of the through hole 83 is configured as the hollow waveguide.

### C. Method of Manufacturing Waveguide Mode Converter

Next, referring to FIG. 3, one embodiment of a method of manufacturing the waveguide mode converter 100 is described.

In one embodiment, first, the supporting substrate 3 including the recess 31 is prepared. The recess 31 is formed in the supporting substrate 3 by, for example, reactive ion etching.

Then, the second conductor layer 4 is formed on the upper surface of the supporting substrate 3 in which the recess 31 is formed. Any appropriate film formation method may be employed as a method of forming the second conductor layer 4. Examples of the film formation method include sputtering, plating, and vapor deposition, and plating is preferred.

Then, the inorganic material substrate 2 is prepared, and the inorganic material substrate 2 and the supporting substrate 3 are directly joined to each other. More specifically, the first joint layer 61 is formed on the lower surface of the inorganic material substrate 2. Further, the second joint layer 62 is formed on the upper surface of the second conductor layer 4. Examples of a method of forming those layers include sputtering, plating, and vapor deposition, and sputtering is preferred. The surface of each of the first joint layer 61 and the second joint layer 62 is polished to be planarized as required.

The direct joining may be achieved by, for example, the following procedure. In a high-vacuum chamber (e.g., about 1×10⁻⁶ Pa), the joining surface of each of components (layers or substrates) to be joined to each other is irradiated with a neutralized beam. In one embodiment, when the surface activation with a neutralized beam is performed, an inert gas is introduced into a chamber, and a high voltage is applied from a DC power source to an electrode arranged in the chamber. With such a configuration, an electric field generated between the electrode (positive electrode) and the chamber (negative electrode) causes electrons to move to generate atomic and ion beams derived from the inert gas. Among the beams that have reached a grid, the ion beam is neutralized at the grid, and hence a beam of neutral atoms is emitted from a fast atom beam source. An atomic species for forming the beam is preferably an inert gas element (e.g., argon (Ar) or nitrogen (N)). At the time of the activation by beam irradiation, a voltage is, for example, from 0.5 kV to 2.0 kV, and a current is, for example, from 50 mA to 200 mA. A period of time of the irradiation with the neutralized beam is, for example, from 10 seconds to 300 seconds, preferably from 30 seconds to 120 seconds.

With this irradiation, each joining surface, more specifically, the inorganic material existing on each of the beam-irradiated surfaces, is activated.

Then, in a vacuum atmosphere at ordinary temperature (23° C.), the activated joining surfaces are brought into contact with each other. A load at the time of the contact may be, for example, from 100 N to 20,000 N. Consequently, the first joint layer 61 and the second joint layer 62 are joined to each other, and the joint portion 6 is formed.

With those steps, a laminate having the structure of the inorganic material substrate 2/the joint portion 6/the second conductor layer 4/the supporting substrate 3 is obtained. The method for the direct joining is not limited thereto, and, for example, a surface activation method using a fast atom beam (FAB) or an ion gun, an atomic diffusion method, or a plasma joining method may also be applied.

The laminate is subjected to heating treatment as required. With this treatment, an increase in the joining strength between the inorganic material substrate and the supporting substrate can be achieved. A temperature of the heating is, for example, from 60° C. to 140° C., preferably from 80° C. to 120° C. A period of time of the heating is, for example, from 10 minutes to 5 hours, preferably from 30 minutes to 3 hours.

Further, other joining methods can be adopted as the method for the direct joining.

For example, in a high-vacuum chamber (e.g., about 1×10⁻⁶ Pa), components (layers or substrates) to be joined to each other are introduced, and the joining surface of a first component that is one of those components (layers or substrates) is irradiated with a fast atom beam using an inert gas such as Ar as an atomic species. Then, from the joining surface, the material of the first component adheres onto the joining surface of a second component that is another one of the components as a sputtering layer. The sputtering layer adhering at this time is a material formed of atoms forming the first component, and may be a material in which atoms included in the inert gas or a device or jig that is used are mixed. In this case, the sputtering layer may be an amorphous layer. In this manner, on the joining surface of the second component, a joining layer formed of the material of the first component is formed. Next, in a vacuum atmosphere at ordinary temperature (23° C.), the beam-irradiated surface of the first component and the surface of the joining layer formed on the second component are brought into contact with each other and pressure is applied thereto.

Even in this manner, the first component and the second component can be joined to each other via the joint portion.

After the joining, amorphous layers of the first component and the second component may be formed between the first component and the joining layer and/or between the second component and the joining layer.

With this joining method being adopted, the thickness of the joining layer can be reduced, and the joining strength can be increased, and hence it is possible to improve the heat dissipation capability and the reliability of the waveguide mode converter 100 as a device.

After that, as required, the inorganic material substrate 2 is polished to be thinned so as to have the above-mentioned thickness. Examples of the polishing method include chemical mechanical polishing (CMP).

Then, the first conductor layer 1 is formed on the upper surface of the inorganic material substrate 2. In one embodiment, after a resist having an opening corresponding to the first conductor layer is formed on the upper surface of the inorganic material substrate 2, the first conductor layer is formed via the resist. Examples of a method of forming a metal film include sputtering, plating, and vapor deposition, and plating is preferred.

Thus, the waveguide mode converter 100 that has the structure of the first conductor layer 1/the inorganic material substrate 2/the joint portion 6/the second conductor layer 4/the supporting substrate 3 and that includes the cavity portion 5 is manufactured.

After that, as required, the waveguide member 8 including the hollow waveguide is positioned with respect to the first end portion E1 of the signal wiring 12. In this manner, the converter 101 provided with a waveguide member is manufactured.

When the waveguide member 8 is the waveguide tube 8a, for example, a casing to which the waveguide tube 8a is fixed is prepared, and the waveguide mode converter 100 is inserted in the casing. In this manner, the waveguide tube 8a is positioned with respect to the first end portion E1 of the signal wiring 12.

Further, as illustrated in FIG. 13, when the waveguide member 8 is the waveguide substrate 8b, for example, the waveguide substrate 8b is fixed to a part of the first conductor layer 1 that excludes the signal wiring 12 and/or a part of the inorganic material substrate 2 exposed from the first conductor layer 1. In this manner, the waveguide substrate 8b is positioned with respect to the first end portion E1 of the signal wiring 12.

Examples of a method of fixing the waveguide substrate 8b include flip-chip mounting and the above-mentioned direct joining, and direct joining is preferred. When the direct joining is selected as the method of fixing the waveguide substrate 8b, the hollow waveguide tube of the waveguide substrate 8b can be stably arranged in the vicinity of the first end portion E1 of the signal wiring 12. Accordingly, it is possible to suppress leakage of the electromagnetic wave from between the hollow waveguide and the signal wiring 12.

The waveguide mode converter according to the embodiments of the present disclosure can be used in a wide range of fields, such as next-generation high-speed communication devices and sensors, and in particular, can be suitably used in next-generation high-speed communication devices.

What is claimed is:

1. A waveguide mode converter, comprising:
an inorganic material substrate;
a first conductor layer arranged on one side of the inorganic material substrate in a thickness direction of the inorganic material substrate;
a supporting substrate arranged on an opposite side to the first conductor layer with respect to the inorganic material substrate;
a cavity portion arranged on the opposite side to the first conductor layer with respect to the inorganic material substrate, and arranged on the inorganic material substrate side of the supporting substrate; and
a backshort conductor layer arranged in the cavity portion,
wherein the first conductor layer includes a signal wiring forming a planar line configured to propagate an electromagnetic wave, and
wherein the signal wiring has one end portion overlapping the cavity portion as viewed from the thickness direction of the inorganic material substrate.

2. The waveguide mode converter according to claim 1,
wherein the inorganic material substrate includes a mode conversion part overlapping the cavity portion as viewed from the thickness direction of the inorganic material substrate,
wherein the waveguide mode converter further comprises a leakage suppression portion configured to suppress leakage of the electromagnetic wave from the mode conversion part, and
wherein the leakage suppression portion is arranged to pass through the inorganic material substrate and surround the mode conversion part.

3. The waveguide mode converter according to claim 2, wherein the leakage suppression portion is formed of a plurality of conductor columns arranged at distances from each other.

4. The waveguide mode converter according to claim 2, wherein the leakage suppression portion is formed of a conductor wall continuously extending so as to surround the mode conversion part.

5. The waveguide mode converter according to claim 1, wherein the first conductor layer further includes a first ground layer arranged at a distance from the one end portion of the signal wiring so as to surround the one end portion of the signal wiring.

6. The waveguide mode converter according to claim 5, further comprising a second ground layer arranged in a part different from the cavity portion between the inorganic material substrate and the supporting substrate,
wherein the second ground layer is arranged so as to surround the cavity portion as viewed from the thickness direction of the inorganic material substrate.

7. The waveguide mode converter according to claim 6, wherein the first ground layer and the second ground layer are electrically connected to each other.

8. The waveguide mode converter according to claim 1, further comprising a waveguide member arranged on an opposite side to the inorganic material substrate with respect to the first conductor layer,
wherein the waveguide member includes a hollow waveguide extending in the thickness direction of the inorganic material substrate, and
wherein the hollow waveguide is opposed to the one end portion of the signal wiring in the thickness direction of the inorganic material substrate.

9. The waveguide mode converter according to claim 8,
wherein the planar line formed of the signal wiring is configured to propagate an electromagnetic wave in a quasi-TEM mode, and
wherein the hollow waveguide is configured to propagate an electromagnetic wave in a TE mode.

10. The waveguide mode converter according to claim 1, further comprising a joint portion configured to join the inorganic material substrate and the supporting substrate to each other.

11. The waveguide mode converter according to claim 1, wherein the inorganic material substrate has a thickness of 100 μm or less.

12. The waveguide mode converter according to claim 1, wherein the inorganic material substrate is formed of quartz glass.

13. The waveguide mode converter according to claim 1, wherein a frequency of the electromagnetic wave allowed to be propagated in the waveguide mode converter is from 20 GHz to 20 THz.
